(19) United States
(12) Patent Application Publication
(10) Pub. No.: US 2026/0106852 A1
(43) Pub. Date: Apr. 16, 2026

(54) ADVANCED ACCESS CONTROL LIST (ACL) BASED ON DATA RESIDENCY

(71) Applicant: Kyndryl, Inc., New York, NY (US)

(72) Inventors: Ajoy Acharyya, Mukundapur (IN); Cesar Augusto Rodriguez Bravo, Alajuela (CR)

(21) Appl. No.: 18/915,573

(22) Filed: Oct. 15, 2024

(51) Int. Cl. H04L 51/212; H04L 51/08; H04L 51/222; H04L 51/48

(52) U.S. Cl. CPC H04L 51/212; H04L 51/08; H04L 51/222; H04L 51/48

(57) ABSTRACT

Embodiments receive a plurality of files from an external system; tag the plurality of files with a residency tag parameter; monitor a user which is attempting to send an email with an attached file of the files to a recipient; determine a recipient location of the recipient; determine that the recipient location of the recipient matches the residency tag parameter; and block transmission of the email with the attached file to the recipient in response to the recipient location of the recipient matching the residency tag parameter.

### BACKGROUND

Aspects of the present invention relate generally to an advanced access control list (ACL) based on data residency and, more particularly, to systems and methods for an advanced access control list (ACL) based on data residency compliance requirement for email attachments.

Data residency refers to legal and regulatory requirements surrounding storage and processing of data within specific geographical regions. In particular, when an email is sent from a region to recipients outside the region, there are certain legal and regulatory requirements that may be involved in the email transmission, including data protection laws, compliance requirements, and jurisdictional considerations.

### SUMMARY

In a first aspect of the invention, there is a computer-implemented method including: receiving, by a computing device, a plurality of files from an external system; tagging, by the computing device, the plurality of files with a residency tag parameter; monitoring, by the computing device, a user which is attempting to send an email with an attached file of the files to a recipient; determining, by the computing device, a recipient location of the recipient; determining, by the computing device, that the recipient location of the recipient matches the residency tag parameter; and blocking, by the computing device, transmission of the email with the attached file to the recipient in response to the recipient location of the recipient matching the residency tag parameter.

In another aspect of the invention, there is a computer program product including one or more computer readable storage media having program instructions collectively stored on the one or more computer readable storage media. The program instructions are executable to: receive a plurality of files from an external system; tag the plurality of files with a residency tag parameter; monitor an operating system (OS) to determine when the OS receives a command to open a file of the files; determine a location of a device of a user which issues the command to open the file; determine that the location of the device of the user matches the residency tag parameter; and block opening of the file in response to the location of the device matching the residency tag parameter.

In another aspect of the invention, there is a system including a processor, a computer readable memory, one or more computer readable storage media, and program instructions collectively stored on the one or more computer readable storage media. The program instructions are executable to: receive a plurality of files from an external system; tag the plurality of files with a residency tag parameter; monitor a user which is attempting to send an email with an attached file of the files to a recipient; determine a recipient location of the recipient; determine whether the recipient location of the recipient matches the residency tag parameter; allow the email with the attached file of the files to be sent to the recipient in response to determining that the recipient location of the recipient does not match the residency tag parameter; and block transmission of the email with the attached file to the recipient in response to determining that the recipient location of the recipient matches the residency tag parameter.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an access control list (ACL) system in accordance with aspects of the present invention.

FIG. 5 shows an example of a data residency attribute of the ACL system in accordance with aspects of the present invention.

FIG. 6 shows an example of a data residency attribute of the ACL system in accordance with aspects of the present invention.

FIG. 7 shows an example of a residency tag of the ACL system in accordance with aspects of the present invention.

FIG. 8 shows an example of a receipt location based on profile information of the ACL system in accordance with aspects of the present invention.

FIG. 9 shows an example of the receipt location based on an internet protocol (IP) address of the ACL system in accordance with aspects of the present invention.

FIG. 10 shows an example of the receipt location based on a destination server location of the ACL system in accordance with aspects of the present invention.

FIG. 11 shows an example of the receipt location based on a relay server location of the ACL system in accordance with aspects of the present invention.

FIG. 12 shows a flowchart of an exemplary method of the ACL system in accordance with aspects of the present invention.

FIG. 13 shows another flowchart of an exemplary method of the ACL system in accordance with aspects of the present invention.

### DETAILED DESCRIPTION

Aspects of the present invention relate generally to an advanced access control list (ACL) based on data residency and, more particularly, to systems and methods for an advanced access control list (ACL) based on a data residency compliance requirement for email attachments. Aspects of the present invention may be implemented as a system, method, or computer program product. The system, method, or computer program product ensures data compliance and meets demands of data protection and privacy regulations. In addition, the system, method, or computer program product controls and enforces data residency requirement. The system, method, and/or computer program product provides an added layer of protection for sensitive information by utilizing data residency requirements. The systems and methods provided herein may be computer implemented methods.

More specifically, the system, method, or computer program product described herein prevents files from leaving a designated region by assigning a data residency attribute to files at an operating system (OS) level. The system, method, or computer program product utilizes the data residency attribute to ensure that any file created within the OS is tagged with an appropriate region designation. Further, the system, method, or computer program product also implements filtering based on the data residency attribute to prevent accidental outbound transmission of files that should remain within a region. In further embodiments, the system, method, or computer program product enables the data residency attribute at the OS level to ensure that all employees using company-provided computers (e.g., desktops, laptops, mobile devices) adhere to the data residence requirements. Embodiments of the present invention protect files on company-provided computers from being sent outside the designated region even in situations where the files on company-provided computers were copied to a personal computer (i.e., not a company-provided computer). Further embodiments of the present invention exclude a virtual shared resource (e.g., a camera feed, a share screen, etc.) from being shared outside of the data region.

The system, method, or computer program product protects files from being transmitted or accessed outside of a designated region. In this way, the present invention is directed to complying with data protection laws, legal requirements, privacy regulations, and jurisdictional considerations. In contrast, known systems solely rely on a geographic location of an email sender without taking into account specific file attachment restrictions. Further, known systems focus on content analysis for determining confidentiality without addressing regional restrictions or routing considerations. Known systems also filter emails based on specific file extensions and do not take into account regional restrictions or other attachment-specific criteria. In embodiments, the systems, methods, and computer program products as described herein make improvements on known systems by implementing data restrictions on files which prevent files from being transmitted or accessed outside of the designated region. Accordingly, in embodiments, the systems, methods, and computer program products address regional restrictions, routing considerations, and attachment-specific criteria by utilizing a data residency attribute within files at the OS level.

Implementations of the present invention are also rooted in computer technology. For example, the steps of tagging, by a computing device, at least one computer file with a data residency attribute, and preventing, by the computing device, transmission of the at least one computer file to a recipient in response to the data residency attribute matching a location of the recipient are computer-based and cannot be performed in the human mind. For example, tagging, by a computing device, at least one computer file with a data residency attribute, and preventing, by the computing device, transmission of the at least one computer file to a recipient in response to the data residency attribute matching a location of the recipient is by definition, performed by a computer and cannot practically be performed in the human mind (or with pen and paper) due to the steps of tagging at least one computer file and preventing transmission of the at least one computer file based on a data residency attribute and a determined location of the intended recipient. Thus, as the methods and systems of the present invention prevent transmission of at least one computer file outside of a designated region, it is simply not possible for the human mind, or for a person using pen and paper, to prevent transmission of at least one computer file in real-time, amongst other features described herein that are also rooted in computer technology. In further aspects of the present invention, embodiments are directed to preventing local access of at least one computer file within a device outside of the designated region, which is also rooted in computer technology.

It should be understood that, to the extent implementations of the invention collect, store, or employ personal information provided by, or obtained from, individuals (for example, users who send or open files restricted by data residency requirements), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

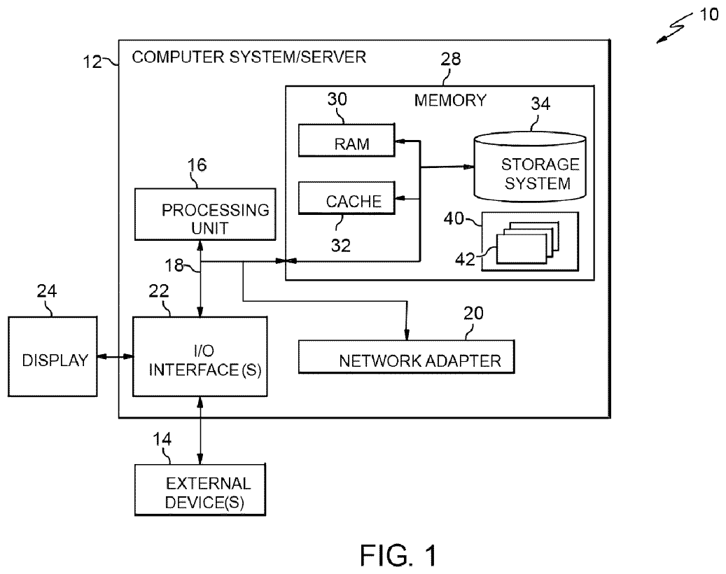

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

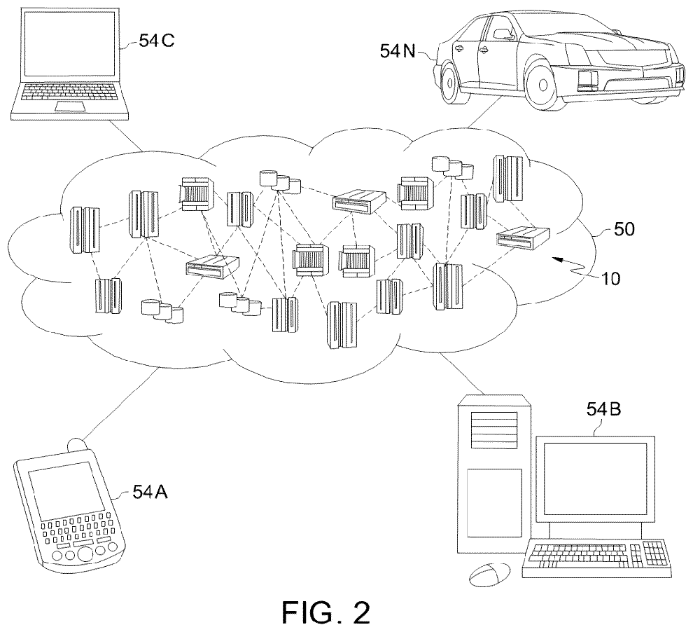

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

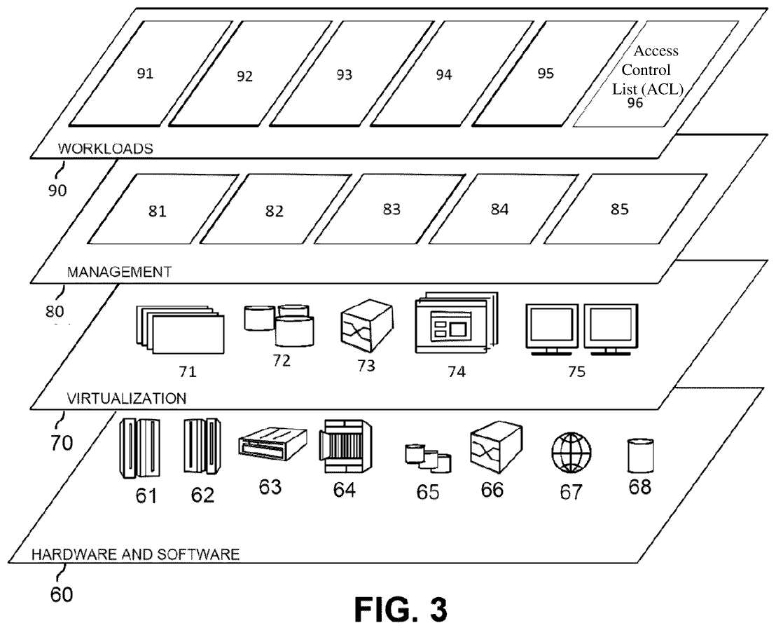

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and access control list (ACL) 96.

Implementations of the invention may include a computer system/server 12 of FIG. 1 in which one or more of the program modules 42 are configured to perform (or cause the computer system/server 12 to perform) one of more functions of the quantum risk assessment 96 of FIG. 3. For example, the one or more of the program modules 42 of the dynamic optimization 96 may be configured to: receive a plurality of files from an external system; tag the plurality of files with a residency tag parameter; monitor a user which is attempting to send an email with an attached file of the files to a recipient; determine a recipient location of the recipient; determine that the recipient location of the recipient matches the residency tag parameter; and block transmission of the email to the recipient in response to the recipient location of the recipient matching the residency tag parameter.

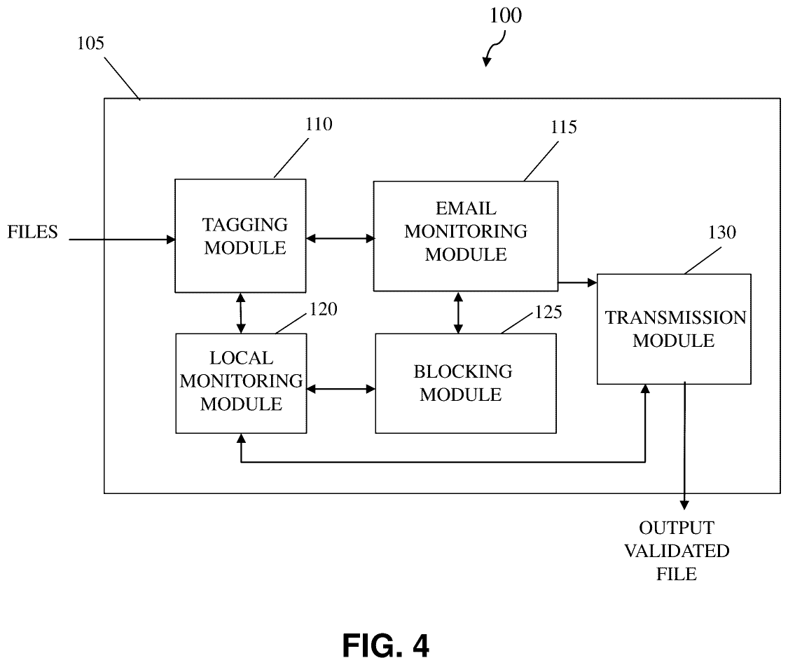

FIG. 4 shows a block diagram of an access control list (ACL) system in accordance with aspects of the invention. In embodiments, the ACL system 100 comprises an ACL environment 105 which includes a tagging module 110, an email monitoring module 115, a local monitoring module 120, a blocking module 125, a transition module 130, each of which may comprise one or more program modules such as program modules 42 described with respect to FIG. 1 and the ACL 96 of FIG. 3.

The ACL system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the tagging module 110 receives a plurality of files from an external system (e.g., an external computing system). In other embodiments, the tagging module 110 receives the plurality of files within the ACL environment 105. In further embodiments, the tagging module 110 assigns a data residency attribute to files at an operating system (OS) level of the ACL environment 105. In aspects of the present invention, the data residency attribute ensures that any files created within the OS level are tagged with a region designation. In further embodiments, the tagging module 110 tagging files with the region designation prevents these files from leaving the region designation (i.e., prevents these files from being sent away from the region designation).

In embodiments of FIG. 4, the tagging module 110 enables the data residency attribute at the OS level to ensure that all users using an organization (e.g., company) provided computing device (e.g., desktop, laptop, mobile device, etc.) adhere to data residency requirements. Accordingly, an employee of the organization who works on computing devices provided by the organization will be affected by the data residency requirements. As an example, since the files of the organization provided computing device are tagged with the region designation, the employee of the organization is prevented from sending these files to a region which is outside of the region designation. Further, even if the employee of the organization copies a file from the organization provided computing device to a personal computing device, the file is still tagged with the region designation. Accordingly, in this situation, the employee of the organization is still prevented from sending the copied file to a region which is outside of the region designation. In further embodiments, personal files on the personal device created by the employee are not affected by the region designation since the tagging module 110 tags the files within computing devices provided by the organization.

In further embodiments of FIG. 4, the tagging module 110 tags the files with the region designation by including a residency_tag parameter in parameters of the files. The tagging module 110 tags the files with a region designation by including the residency_tag using different mechanisms. In an embodiment, the tagging module 110 tags the files in a default mechanism by including the residency_tag parameter to provide a restrictive region designation which allows the files to be transmitted or opened in only a same country as a region of a file creator of the files. For example, in response to the file creator of a file being located in Brazil, the tagging module 110 tags the file with the residency_tag parameter of Brazil to ensure that the file is transmitted or opened only in Brazil and not in any region outside of Brazil. In another embodiment, the tagging module 110 tags the files in the default mechanism including the residency_tag parameter to provide a permissive region designation which allows the files to be transmitted or opened in at least one country (e.g., all countries).

In further embodiments of FIG. 4, the tagging module 110 tags the files in a user profile mechanism by including the residency_tag parameter to provide a user parameter designation which allows the files to be transmitted or opened in only a same country as a user parameter within a user profile. For example, in response to the user parameter within the user profile being the United States, the tagging module 110 tags a file with the residency_tag parameter of the United States in accordance with the user profile to ensure that the file is transmitted or opened only in the United states and not in any region outside of the United States. In another embodiment, the tagging module 110 tags the files in the user profile mechanism including the residency_tag parameter to provide a user restriction designation which allows the files to be transmitted or opened in only a region allowed by a user restriction within the user profile and restricts the files from being transmitted or opened in any region restricted by the user restriction within the user profile. For example, in response to the user restriction within the user profile restricting access within the European Union and allowing access within the United States, the tagging module 110 tags the file with the residency_tag parameter of restricting the European Union and allowing the United States to ensure that the file is transmitted or opened in the United States, restricted from being transmitted or opened in the European Union, and allowed to be transmitted or opened in any other region.

In further embodiments of FIG. 4, the tagging module 110 tags the files in the user profile mechanism by including the residency_tag parameter to provide a role designation which restricts the files from being transmitted or opened in accordance with a role of the user profile. For example, in response to the role of the user profile being finance, the tagging module 110 tags the file with the residency_tag parameter of restricting Japan in accordance with the role of the user profile to ensure that the file is restricted from being transmitted or opened in Japan and allowed to be transmitted or opened in any other region outside of Japan.

In aspects of the present invention, the tagging module 110 tags the files in a document type mechanism by including the residency_tag parameter to provide a document designation which allows a certain type of document of the files to be transmitted or opened in a country which corresponds with the certain type of the document of the files. For example, in response to DOC files being allowed within all countries, the tagging module 110 tags DOC files with the residency_tag parameter of allowing all countries in accordance with DOC files allowing transmission to all countries to ensure that the files are allowed to be transmitted or opened in any region. In another example, in response to ZIP files restricting Russia and China, the tagging module 110 tags ZIP files with the residency_tag parameter of restricting Russia and China in accordance with ZIP files preventing transmission or opening of ZIP files to Russia and China and allowing transmission or opening of ZIP files to regions outside of Russia and China.

In further aspects of the present invention, the tagging module 110 tags the files in a content category mechanism by including the residency_tag parameter to provide a content category designation which allows the files to be transmitted or opened in a country which corresponds with the content category of the files. For example, in response to the tagging module 110 determining that a content category of a file is public, the tagging module 110 tags the public file with the residency_tag parameter of restricting Russia and China in accordance with the content category of public to ensure that the file is restricted from being transmitted or opened to Russia and China and allows transmission or opening of the public file to regions outside of Russia and China. In another example, in response to the tagging module 110 determining that a content category of a file is restricted, the tagging module 110 tags the restricted file with the residency_tag parameter of restricting Germany and Poland in accordance with the content category of restricted to ensure that the file is restricted from being transmitted or opened to Germany and Poland and allows transmission or opening of the restricted file to regions outside of Germany and Poland. In another example, in response to the tagging module 110 determining that a content category of a file is sensitive, the tagging module 110 tags the sensitive file with the residency_tag parameter of restricting the country to a same region as the creator of the file, which is Australia, and allows transmission or opening of the sensitive file to Australia, and restricts the transmission or opening of the sensitive file to regions outside of Australia.

In embodiments of FIG. 4, the tagging module 110 tags the files in a size mechanism by including the residency_tag parameter to provide a size designation which restricts the files from being transmitted or opened in accordance with the size of the files. For example, in response to the tagging module 110 determining that a size a file is less than one megabyte (i.e. less than 1 Mb), the tagging module 110 tags the file with the residency_tag parameter of restricting France in accordance with the size of the file to ensure that the file is restricted from being transmitted or opened to France and allows transmission or opening of the public file to regions outside of France. In another example, in response to the tagging module 110 determining that the size of the file is greater than ten megabytes (i.e., greater than 10 Mb), the tagging module 110 tags the file with the residency_tag parameter of restricting Brazil, Canada, and Mexico in accordance with the size of the file to ensure that the file is restricted from being transmitted or opened to Brazil, Canada, and Mexico and allows transmission or opening of the file to regions outside of Brazil, Canada, and Mexico.

In FIG. 4, the tagging module 110 is not limited to the above described mechanisms and may use other mechanisms. As an example, the tagging module 110 tags the file with region designations by including the residency_tag based on a global designation included in a centrally located configuration file to provide a permissive region designation which allow the files to be transmitted or opened in only a same country as the global designation included in the centrally located configuration file. For example, in response to the tagging module 110 determining that the global designation included in the centrally located configuration file includes India, the tagging module 110 tags the file with the residency_tag parameter of India in accordance with the global designation included in the centrally located configuration file to ensure that the file is allowed to be transmitted or opened to India and restricts transmission or opening of the public file to regions outside of India.

In further embodiments, the tagging module 110 creates an OS image residency policy which restricts specific region designations. As an example, the tagging module 110 creates the OS image residency policy which restricts transmission or opening of the files to South America. The tagging module 110 scans the ACL environment 105 for files that don't have the residency_tag and applies the residency_tag based on the OS image residency policy. In this example, the tagging module 110 tags the files which don't have the residency_tag with residency_tag parameter to restrict transmission or opening to South America to ensure that these files are restricted from being transmitted or opened to South America and allows transmission or opening of these files to regions outside of South America. In other embodiments, a user (e.g., an admin user) may interact with a graphical user interface (GUI) to select at least one region of the OS image residency policy to restrict transmission or opening of the file to the at least one region. In further embodiments, a user (e.g., an admin user) may interact with the GUI to select at least one region of the OS image residency policy to allow transmission or opening of the file to the at least one region. In aspects of the present invention, the tagging module 110 enhances the ability to control and enforces data residency requirements across files to add a layer of protection for sensitive information.

In embodiments of FIG. 4, the email monitoring module 115 monitors a user within the ACL environment 105 to determine when the user attempts to send an email with an attached file which has the residency_tag parameter. In further embodiments, the email monitoring module 115 determines a recipient location of the email by detecting whether there is a location in a user profile of a recipient. For example, the email monitoring module 115 monitors when the user is attempting to send an email with the attached file which has the residency_tag parameter of restricting Cuba to a recipient which has a location of Mexico in the user profile of the recipient. In this scenario, the email monitoring module 115 determines that the recipient location of Mexico is different from the residency_tag parameter of restricting Cuba and allows for the email with the attached file to be passed to the transmission module 130 for email transmission. In another example, the email monitoring module 115 monitors when the user is attempting to send the email with the attached file which has the residency_tag parameter of restricting Cuba to a recipient which has a location of Cuba in the user profile of the recipient. In this scenario, the email monitoring module 115 determines that the recipient location of Cuba is the same as the residency_tag parameter of restricting Cuba and sends the email with the attached file to the blocking module 125 for blocking the email with the attached file so that the email with the attached file is prevented from being passed to the transmission module 130 for email transmission.

In embodiments of FIG. 4, the email monitoring module 115 determines the recipient location of the email by detecting the location of the recipient based on an IP address of the receipt. In further embodiments, the email monitoring module 115 determines the IP address of the recipient based on an email client loaded on a device of the user to gather the IP address of the recipient. In aspects of the present invention, the email monitoring module 115 determines the IP address of the recipient by sending a ghost email to the recipient to gather the IP address of the recipient.

In embodiments of FIG. 4, the email monitoring module 115 determines the recipient location of the email by gathering data from an email server to determine a location of the email server. In further embodiments, the email monitoring module 115 determines the recipient location of the email server based on geolocation of the email server, the IP address of the email server, etc. In aspects of the present invention, the email monitoring module 115 prevents transmission of the email based on the location of the email server. In this situation, the email monitoring module 115 prevents transmission of the email based on the location of the email server and not on a location of the user who attempts to send the email with the attached file. In further aspects of the present invention, the email server can be a relay server, a recipient email server, etc.

In embodiments of FIG. 4, the email monitoring module 115 is not limited to the above described scenarios for determining the recipient location and may use other scenarios for determining the recipient location. As an example, the email monitoring module 115 may communicate with a first OS image residency policy on a computing device of the user to determine the residency_tag for files on a computing device of the user which doesn't have the residency_tag. The email monitoring module 115 may also communicate with a second OS image residency policy on a computing device of the recipient to determine the recipient location. In an example, the email monitoring module 115 monitors when the user is attempting to send the email with the attached file which has no residency tag. In this situation, the email monitoring module 115 determines the residency_tag of restricting Ghana from the first OS image residency policy on a computing device of the user and inserts the residency_tag into the attached file. The email monitoring module 115 also determines that the recipient location is Ghana based on the second OS image residency policy on a computing device of the recipient. In this scenario, the email monitoring module 115 determines that the recipient location of Ghana is the same as the residency_tag parameter of restricting Ghana and sends the email with the attached file to the blocking module 125 for blocking the email with the attached file so that the email with the attached file is prevented from being passed to the transmission module 130 for email transmission.

In situations where the email monitoring module 115 determines that the user within the ACL environment 105 is attempting to send the email with an attached file which does not have the residency_tag parameter and the computing device of the user does not have an OS image residency policy, the email monitoring module 115 allows for the email with the attached file to be passed to the transmission module 130 for email transmission.

In embodiments of FIG. 4, the transmission module 130 receives emails with an attached filed that has not been blocked by the email monitoring module 115 and sends the received email with the attached file to the recipient location. In further embodiments, the transmission module 130 also marks the attached file as a validated file and outputs the validated file to the external system (e.g., the external computing system). In aspects of the present invention, the transmission module 130 marks the attached file as the validated file and outputs the validated file to the computing device of the user within the ACL environment 105.

In embodiments of FIG. 4, the blocking module 125 receives an email with an attachment file from the email monitoring module 115 based on the residency_tag and blocks the email with the attachment file from being sent to the transmission module 130. In this scenario, the blocking module 125 prevents transmission of the email with the attachment file because the attachment file does not comply with data residency requirements and provides protection for sensitive information in the attachment file.

In embodiments of FIG. 4, the local monitoring module 120 monitors the OS within the ACL environment 105 to determine when the OS receives a command to open a file. In aspects of the present invention, the local monitoring module 120 determines the residency_tag parameter of the file and also determines whether the file can be opened based on the determined residency_tag parameter. In further embodiments, the local monitoring module 120 allows the file to be opened by the transmission module 130 based on the determined residency tag parameter being different from a location of the computing device of the user. As an example, the local monitoring module 120 may communicate with a first OS image residency policy on a computing device of the user to determine the residency_tag for files on a computing device of the user which don't have the residency_tag. The local monitoring module 120 may also determine the residency_tag by using the same mechanisms as the email monitoring module 115. The local monitoring module 120 may also communicate with a second OS image residency policy on the computing device of the user to determine the location of the computing device of the user. In an example, the local monitoring module 120 allows the file to be opened by the transmission module 130 based on the residency tag parameter being determined to restrict China, which is different from the location of the computing device of the user being within the United States. In aspects of the present invention, the local monitoring module 120 sends the file to the blocking module 125 in response to the determined residency tag parameter matching the location of the computing device of the user. In another example, the local monitoring module 120 sends the file to the blocking module 125 in response to the residency_tag parameter being determined to restrict Argentina, which is the same as the location of the computing device of the user being Argentina.

In embodiments of FIG. 4, the transmission module 130 receives the file which has not been blocked by the local monitoring module 120 and opens the file at the computing device of the user. In further embodiments, the transmission module 130 also marks the file as a validated file and outputs the validated file to the external system (e.g., the external computing system). In aspects of the present invention, the transmission module 130 marks the file as the validated file and outputs the validated file to the computing device of the user within the ACL environment 105.

In embodiments of FIG. 4, the blocking module 125 receives the file from the local monitoring module 120 based on the residency_tag matching the location of the computing device of the user and blocks opening of the file and prevents the file from being sent to the transmission module 130. In this scenario, the blocking module 125 prevents opening and transmission of the file because the file does not comply with data residency requirements and provides protection for sensitive information in the file. The blocking module 125 also displays an error message to the user through the computing device of the user. The blocking module 125 sends a report to a creator of the file. In aspects of the invention, the report includes information that states that someone opened the file at a restricted location. In further embodiments, the blocking module 125 deletes the file from the computing device of the user for security and regulatory reasons.

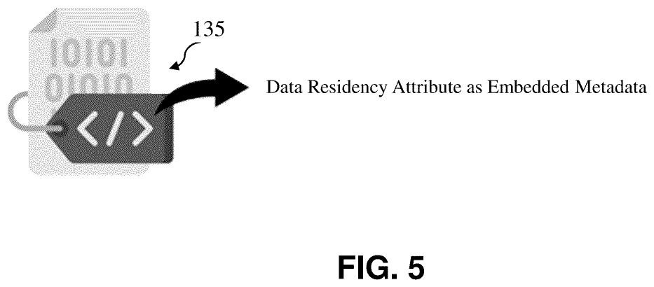

FIG. 5 shows an example of a data residency attribute of the ACL system 100 in accordance with aspects of the present invention. In FIG. 5, the data residency attribute 135 of the ACL environment 105 comprises an embedded metadata as a residency_tag parameter of a file.

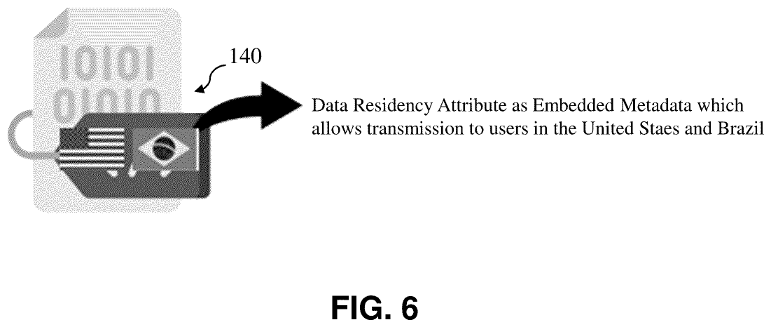

FIG. 6 shows an example of the data residency attribute of the ACL system 100 in accordance with aspects of the present invention. In an example of FIG. 5, the data residency attribute 140 of the ACL environment 105 comprises the embedded metadata as the residency_tag parameter of the file which allows transmission to users in the United States and Brazil.

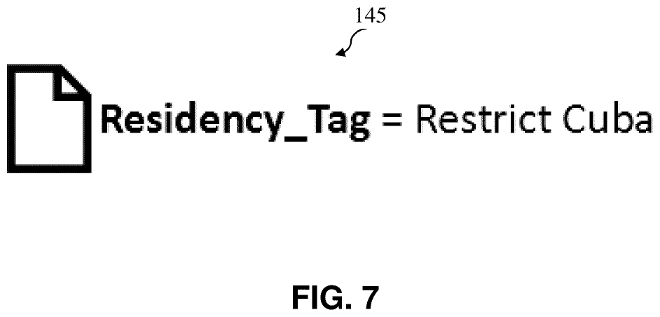

FIG. 7 shows an example of a residency tag of the ACL system 100 in accordance with aspects of the present invention. In an example of FIG. 7, the residency_tag parameter 145 of the file in the ACL environment 105 restricts transmission of the file to Cuba.

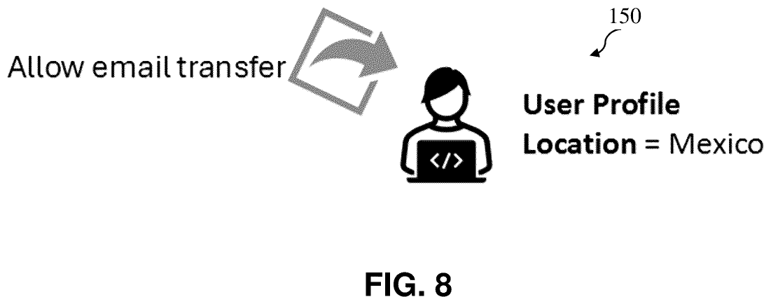

FIG. 8 shows an example of a receipt location based on profile information of the ACL system 100 in accordance with aspects of the present invention. In an example of FIG. 8, the receipt location 150 is Mexico based on the user parameter within the user profile. Accordingly, the email monitoring module 115 of the ACL environment 105 determines that the recipient location 150 of Mexico is different from the residency_tag parameter 145 of restricting Cuba and allows for the email with the attached file to be opened or passed to the transmission module 130 for email transmission

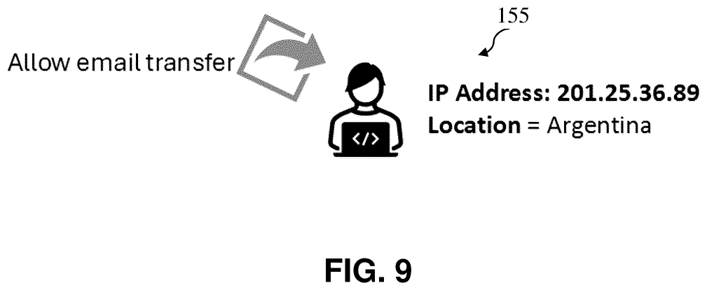

FIG. 9 shows an example of the receipt location based on an internet protocol (IP) address of the ACL system 100 in accordance with aspects of the present invention. In an example of FIG. 9, the receipt location 155 is Argentina based on the IP address of the recipient. Accordingly, the email monitoring module 115 of the ACL environment 105 determines that the recipient location 155 of Argentina is different from the residency_tag parameter 145 of restricting Cuba and allows for the email with the attached file to be opened or passed to the transmission module 130 for email transmission.

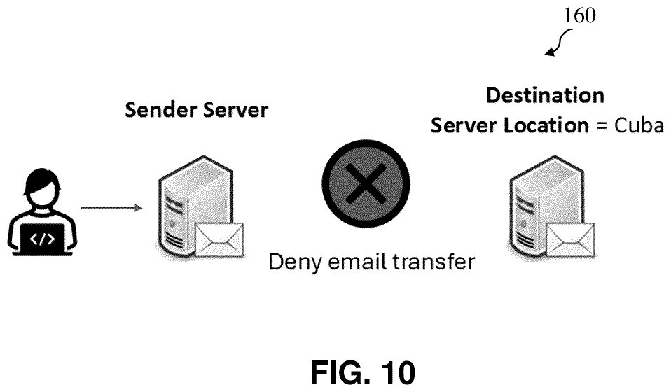

FIG. 10 shows an example of the receipt location based on a destination server location of the ACL system 100 in accordance with aspects of the present invention. In an example of FIG. 10, the recipient location 160 is Cuba based on the destination server location determined to be located in Cuba. Accordingly, the email monitoring module 115 of the ACL environment 105 determines that the recipient location 160 of Cuba is the same as the residency_tag parameter 145 of restricting Cuba and sends the email with the attached filed to the blocking module 125. The blocking module 125 blocks the email with the attached file from being opened or transmitted.

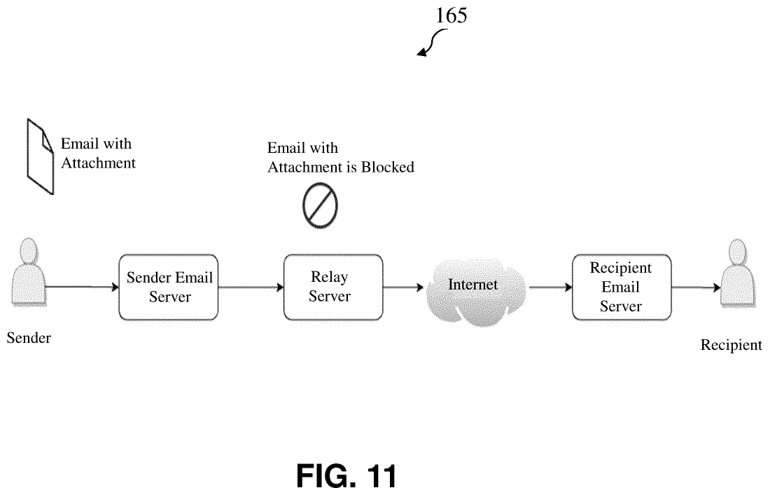

FIG. 11 shows an example of the receipt location based on a relay server location of the ACL system 100 in accordance with aspects of the present invention. In the example 165 of FIG. 11, the sender attempts to send an email with an attached file to a recipient. In this example, the email monitoring module 115 of the ACL environment 105 may communicate with an OS image residency policy on a computing device of the user to determine the residency_tag for files on a computing device of the user which don't have the residency_tag. The email monitoring module 115 may also gather data from the relay server to determine a location of the relay server. In an example, the email monitoring module 115 determines that the residency_tag from the OS image residency policy on a computing device of the user is the same as the location of the relay server. In this scenario, the email monitoring module 115 determines that the location of the relay server is the same as the residency_tag parameter and sends the email with the attached file to the blocking module 125. The blocking module 125 blocks the email with the attached file so that the email with the attached file is prevented from being passed to the transmission module 130 for email transmission.

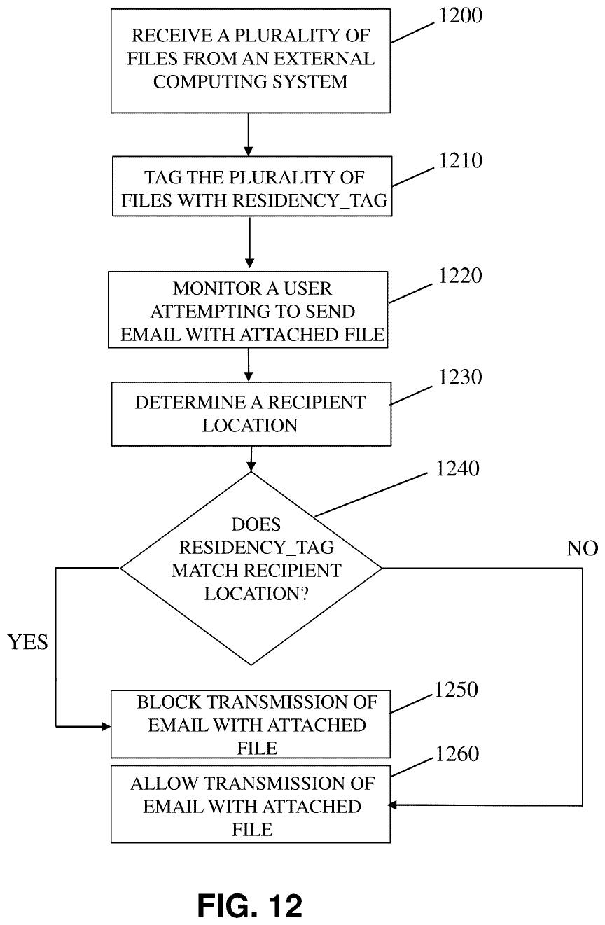

FIG. 12 shows a flowchart of an exemplary method of the quantum risk assessment system in accordance with aspects of the present invention. Steps of the method may be carried out in the ACL environment 105 of FIG. 4.

At step 1200, the system receives, at the tagging module 110, a plurality of files from an external system. In embodiments and as described with respect to FIG. 4, the tagging module 110 receives the plurality of files from an external computing system.

At step 1210, the system tags, at the tagging module 110, the plurality of files with a residency_tag. In embodiments and as described with respect to FIG. 4, the tagging module 110 tags the plurality of files with a region designation by including the residency_tag in parameters of the files.

At step 1220, the system monitors, at the email monitoring module 115, a user within an ACL environment 105 to determine when the user attempts to send an email with an attached file. In embodiments and as described with respect to FIG. 4, the attached file has the residency_tag parameter.

At step 1230, the system determines, at the email monitoring module 115, a recipient location of the email with the attached file. In embodiments and as described with respect to FIG. 4, the email monitoring module 115 determines the recipient location by detecting whether there is a location in a user profile of a recipient of the email.

At step 1240, the system determines, at the email monitoring module 115, whether the residency_tag parameter matches the recipient location. At step 1250, the system blocks, at the blocking module 125, the email with the attached file from being sent to the recipient in response to determining that the residency_tag parameter matches the recipient location.

At step 1260, the system allows, at the transmission module 130, transmission of the email with the attached file to the recipient in response to determining the residency_tag parameter does not match the recipient location.

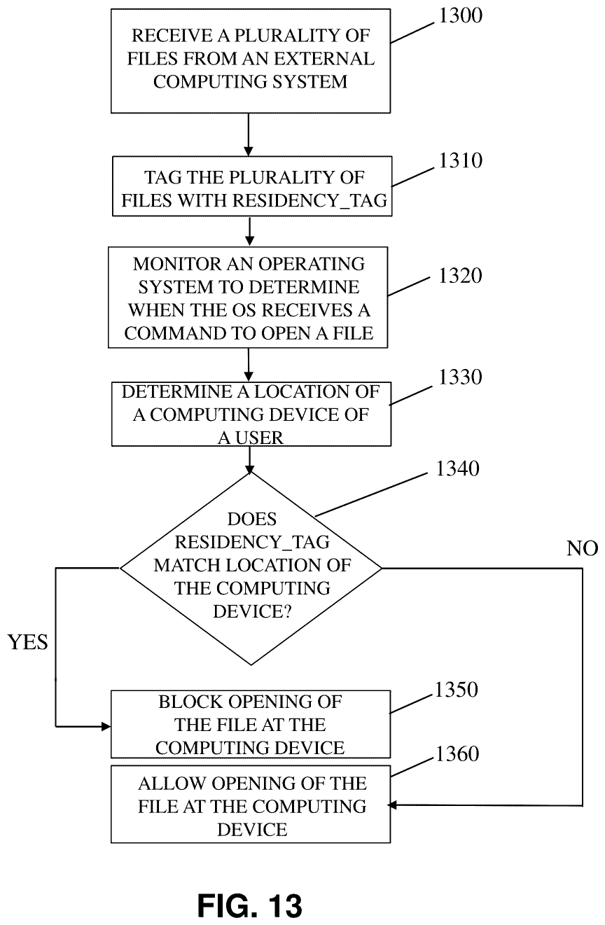

FIG. 13 shows a flowchart of an exemplary method of the quantum risk assessment system in accordance with aspects of the present invention. Steps of the method may be carried out in the ACL environment 105 of FIG. 4.

At step 1300, the system receives, at the tagging module 110, a plurality of files from an external system. In embodiments and as described with respect to FIG. 4, the tagging module 110 receives the plurality of files from an external computing system.

At step 1310, the system tags, at the tagging module 110, the plurality of files with a residency_tag. In embodiments and as described with respect to FIG. 4, the tagging module 110 tags the plurality of files with a region designation by including the residency_tag in parameters of the files.

At step 1320, the system monitors, at the local monitoring module 120, an operating system (OS) within the ACL environment 105 to determine when the OS receives a command to open a file. In embodiments and as described with respect to FIG. 4, the file has the residency_tag parameter.

At step 1330, the system determines, at the local monitoring module 120, a location of a computing device of a user. At step 1340, the system determines, at the local monitoring module 120, whether the residency_tag parameter matches the location of the computing device of the user.

At step 1350, the system blocks, at the blocking module 125, the file from being opened at the computing device of the user in response to determining that the residency_tag parameter matches the location of the computing device of the user. At step 1360, the system allows, at the transmission module 130, the file to be opened at the computing device of the user in response to determining the residency_tag parameter does not match the location of the computing device of the user.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, a plurality of files from an external system;
tagging, by the computing device, the plurality of files with a residency tag parameter;
monitoring, by the computing device, a user which is attempting to send an email with an attached file of the files to a recipient;
determining, by the computing device, a recipient location of the recipient;
determining, by the computing device, that the recipient location of the recipient matches the residency tag parameter; and
blocking, by the computing device, transmission of the email with the attached file to the recipient in response to the recipient location of the recipient matching the residency tag parameter.

2. The computer-implemented method of claim 1, wherein the tagging the plurality of files with the residency tag parameter comprises tagging the plurality of files with the residency tag parameter based on a user parameter within a user profile of the user.

3. The computer-implemented method of claim 1, wherein the tagging the plurality of files with the residency tag parameter comprises tagging the plurality of files with the residency tag parameter based on a role of a user profile of the user.

4. The computer-implemented method of claim 1, wherein the tagging the plurality of files with the residency tag parameter comprises tagging the plurality of files with the residency tag parameter based on a type of a document of the files.

5. The computer-implemented method of claim 1, wherein the tagging the plurality of files with the residency tag parameter comprises tagging the plurality of files with the residency tag parameter based on a content category of the files.

6. The computer-implemented method of claim 1, wherein the tagging the plurality of files with the residency tag parameter comprises tagging the plurality of files with the residency tag parameter based on an operating system (OS) image residency policy.

7. The computer-implemented method of claim 1, wherein the determining the recipient location of the recipient comprises determining the recipient location of the recipient based on a location in a recipient profile of the recipient.

8. The computer-implemented method of claim 1, wherein the determining the recipient location of the recipient comprises determining the recipient location of the recipient based on an IP address of the recipient.

9. The computer-implemented method of claim 1, wherein the determining the recipient location of the recipient comprises determining the recipient location of the recipient based on an operating system (OS) image residency policy.

10. The computer-implemented method of claim 1, wherein the residency tag parameter comprises a region designation.

11. The computer-implemented method of claim 1, wherein the computing device includes software provided as a service in a cloud environment.

12. A computer program product comprising one or more computer readable storage media having program instructions collectively stored on the one or more computer readable storage media, the program instructions executable to:
receive a plurality of files from an external system;
tag the plurality of files with a residency tag parameter;
monitor an operating system (OS) to determine when the OS receives a command to open a file of the files;
determine a location of a device of a user which issues the command to open the file;
determine that the location of the device of the user matches the residency tag parameter; and
block opening of the file in response to the location of the device matching the residency tag parameter.

13. The computer program product of claim 12, wherein the program instructions to tag the plurality of files with the residency tag parameter comprises program instructions to tag the plurality of files with the residency tag parameter based on a user parameter within a user profile of the user.

14. The computer program product of claim 12, wherein the program instructions to tag the plurality of files with the residency tag parameter comprises program instructions to tag the plurality of files with the residency tag parameter based on a role of a user profile of the user.

15. The computer program product of claim 12, wherein the program instructions to tag the plurality of files with the residency tag parameter comprises program instructions to tag the plurality of files with the residency tag parameter based on a type of a document of the files.

16. The computer program product of claim 12, wherein the program instructions to tag the plurality of files with the residency tag parameter comprises program instructions to tag the plurality of files with the residency tag parameter based on a content category of the files.

17. The computer program product of claim 12, wherein the program instructions to tag the plurality of files with the residency tag parameter comprises program instructions to tag the plurality of files with the residency tag parameter based on a first OS image residency policy.

18. The computer program product of claim 12, wherein the program instructions to determine the location of the device of the user comprises program instructions to determine the location of the device of the user based on a second OS image residency policy.

19. The computer program product of claim 12, wherein the residency tag parameter comprises a region designation.

20. A system comprising:
a processor, a computer readable memory, one or more computer readable storage media, and program instructions collectively stored on the one or more computer readable storage media, the program instructions executable to:
receive a plurality of files from an external system;
tag the plurality of files with a residency tag parameter;
monitor a user which is attempting to send an email with an attached file of the files to a recipient;
determine a recipient location of the recipient;
determine whether the recipient location of the recipient matches the residency tag parameter;
allow the email with the attached file of the files to be sent to the recipient in response to determining that the recipient location of the recipient does not match the residency tag parameter; and
block transmission of the email with the attached file to the recipient in response to determining that the recipient location of the recipient matches the residency tag parameter.
